(19) United States
(12) Patent Application Publication
(10) Pub. No.: US 2026/0090675 A1
(43) Pub. Date: Apr. 2, 2026

(54) ADVANCED GREASE-CAPTURING SOLUTION FOR BARBECUE GRILLS

(71) Applicant: John Michael Springer, Beaverton, OR (US)

(72) Inventor: John Michael Springer, Beaverton, OR (US)

(21) Appl. No.: 19/336,103

(22) Filed: Sep. 22, 2025

Related U.S. Application Data
(60) Provisional application No. 63/700,560, filed on Sep. 27, 2024.

(51) Int. Cl. A47J 37/07; F24C 15/14

(52) U.S. Cl. CPC A47J 37/0786; A47J 37/0704; F24C 15/14

(57) ABSTRACT

A grease capturing insert adapted for use with barbecue grills. The insert includes an oxygen depriving, multi-channel grease drainage tray that sits underneath the food being cooked and collects dripping grease before it hits the fire. The drainage tray sits at an angle, so grease is quickly drained away from the heat source and into a collection tray that is behind an insulation wall. The drainage tray is made of multiple channel members. Each channel member has a Y-shaped cross-section. The bottom of each “Y” defines a narrow center channel that grease is funneled into when it falls into the channel member. While in the narrow center channel, grease is deprived of oxygen and flare ups are theoretically impossible.

### CROSS REFERENCE TO RELATED APPLICATIONS

This application claims the benefit of U.S. Provisional Patent Application 63/700,560, filed on Sep. 27, 2024, and incorporated herein by reference.

### STATEMENT REGARDING FEDERALLY SPONSORED RESEARCH AND DEVELOPMENT

Not Applicable.

### FIELD OF THE INVENTION

This invention relates to grease drainage trays, and more particularly to an advanced solution for grease drainage trays.

### BACKGROUND

Grease drainage systems for barbecue grills have long suffered from multiple fundamental problems that compromise both safety and cooking performance. Traditional horizontal grease trays are prone to flare-ups and fires when grease accumulates and comes into contact with heat sources and oxygen. The combination of these three elements-heat, grease, and oxygen-creates dangerous conditions that can lead to uncontrolled fires, burned food, and potential injury to users.

Existing grease management solutions fail to adequately address several critical issues. Most prior art grease trays simply collect grease in open, horizontal containers that remain exposed to both heat and oxygen, providing ideal conditions for ignition. These systems often allow grease to pool near the heat source, increasing temperatures and fire risk. Additionally, conventional grease trays frequently lack proper drainage angles, causing grease to stagnate rather than flow away from danger zones.

Current grease collection systems also suffer from inadequate heat insulation, allowing collected grease to reach dangerous temperatures that promote spontaneous combustion. Many existing products provide insufficient capacity for grease collection, leading to overflow and spillage that creates additional fire hazards. The lack of oxygen-depriving design features in prior art systems means that even small amounts of accumulated grease 21 can easily ignite when exposed to heat sources.

Furthermore, existing solutions often fail to efficiently direct grease away from cooking areas, resulting in poor grease management that affects food quality through unwanted flare-ups and uneven heating. Many prior art products are difficult to clean and maintain, leading to grease buildup over time that exacerbates safety concerns.

Therefore, there is a significant need for an improved grease management system that effectively separates grease from heat sources, minimizes oxygen exposure to collected grease, provides adequate insulation to prevent overheating, utilizes gravity for efficient grease drainage, and offers easy maintenance while enhancing both safety and cooking performance. The present invention addresses these critical shortcomings through an innovative design that fundamentally changes how grease is captured, contained, and isolated from ignition sources.

### SUMMARY OF THE INVENTION

The present device is a grease-capturing insert adapted for use with barbecue grills having a heat source. The grease-capturing insert comprises an oxygen depriving, multi-channel grease drainage tray having an elevated end and a lower end. The elevated end is at a height that is greater than a height of the lower end. The oxygen depriving, multi-channel grease drainage tray comprises a plurality of channel members. Each channel member comprising a narrow center channel running longitudinally along the length of a Y-shaped cross-section of the channel member.

Any grease that drops from food being cooked on the barbecue grill is directed into the Y-shaped cross-section of each channel member and further wherein the grease is funneled down into the narrow center channel and thereby deprived of oxygen and unable to cause a flare-up. An insulation layer covers the bottom of the grease drainage tray. The insulation layer providing a layer of heat insulation between the drainage tray and the heat source. A grease collection tray is provided that is fluidly connected to the lower end of the grease drainage tray and all of the grease that is collected in the grease drainage tray drains by gravity from the lower end into the grease collection tray.

An insulation wall is next to the grease collection tray. The insulation wall is attached to the lower end of the drainage tray and the insulation wall is interior to the grease collection tray. The insulation wall provides insulation for the grease collection tray from the heat source.

The present invention addresses the drawbacks of the prior art by providing an improved grease management system that effectively separates grease from heat sources, minimizes oxygen exposure to collected grease, provides adequate insulation to prevent overheating, utilizes gravity for efficient grease drainage, and offers easy maintenance while enhancing both safety and cooking performance. The innovative design fundamentally changes how grease is captured, contained, and isolated from ignition sources through a unique combination of angled drainage channels with Y-shaped cross-sections, oxygen-depriving narrow center channels, integrated insulation layers, and gravity-assisted flow to remote collection areas. This comprehensive approach eliminates the critical shortcomings of existing horizontal grease trays and open collection systems, providing superior fire prevention, enhanced food quality, and safer grilling operations. Other features and advantages of the present invention will become apparent from the following more detailed description, taken in conjunction with the accompanying drawings, which illustrate, by way of example, the principles of the invention.

### DESCRIPTION OF THE DRAWINGS

FIG. 1 is cross-sectional side view of the preferred embodiment of the present advanced grease capturing solution for barbecue grills;

FIG. 2 is a top perspective cut-off view of the preferred embodiment of the advanced grease capturing solution for barbecue grills;

FIG. 3(a) is a frontal view of a channel member of the preferred embodiment;

FIG. 3(b) is a perspective view of a channel member of the preferred embodiment;

FIG. 3(c) is another perspective view of the channel member of the preferred embodiment;

FIG. 4 shows a plurality of channel members being linked together to make up a drainage tray; and,

FIG. 5 shows the preferred embodiment in operational position inside a barbecue grill.

### DETAILED DESCRIPTION OF THE PREFERRED EMBODIMENT

Illustrative embodiments of the invention are described below. The following explanation provides specific details for a thorough understanding of and enabling description for these embodiments. One skilled in the art will understand that the invention may be practiced without such details. In other instances, well-known structures and functions have not been shown or described in detail to avoid unnecessarily obscuring the description of the embodiments.

Unless the context clearly requires otherwise, throughout the description and the claims, the words “comprise,” “comprising,” and the like are to be construed in an inclusive sense as opposed to an exclusive or exhaustive sense; that is to say, in the sense of “including, but not limited to.” Words using the singular or plural number also include the plural or singular number respectively. Additionally, the words “herein,” “above,” “below” and words of similar import, when used in this application, shall refer to this application as a whole and not to any particular portions of this application. When the claims use the word “or” in reference to a list of two or more items, that word covers all of the following interpretations of the word: any of the items in the list, all of the items in the list and any combination of the items in the list. When the word “each” is used to refer to an element that was previously introduced as being at least one in number, the word “each” does not necessarily imply a plurality of the elements, but can also mean a singular element. When the words “substantially” or “about” are used, if a quantitative measurement is necessary, within 95% of “complete” or “exact” should be considered the meaning. The term “the invention” or “the present invention” should always be construed as “an embodiment of the invention.”

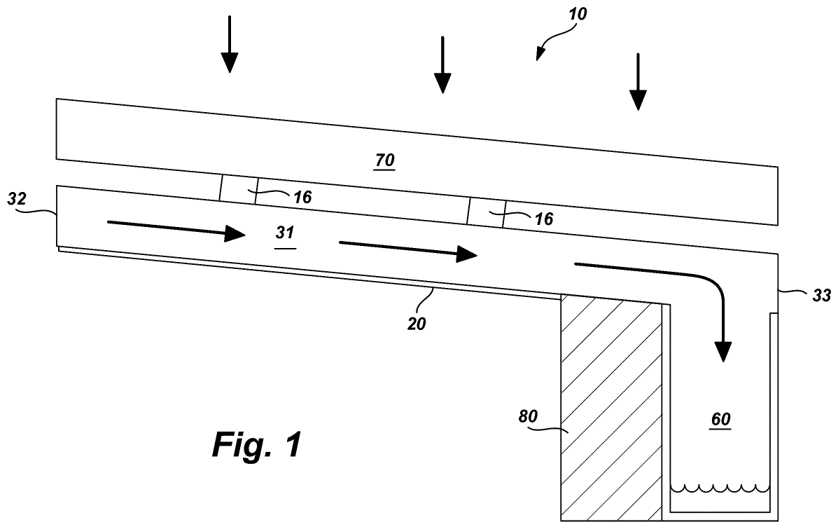

FIG. 1 is cross-sectional, side view of the preferred embodiment of the present advanced grease capturing insert 10 for a barbecue grill 15. The basic components of the grease capturing insert 10 are the grease drainage tray 31, the grease collection tray 60, the insulation wall 80 and the insulation layer 20. The grease drainage tray 31 has an elevated end 32 that is at a height that is greater than that of the lower end 33 of the drainage tray 31. This allows gravity to carry any grease in the drainage tray 31 downhill to the grease collection tray 60. When grease is in the drainage tray 31, the insulation layer 20 provides protection from the heat source 50. When the grease reaches the grease collection tray 60, the insulation wall 80 provides the protection from the heat source 50.

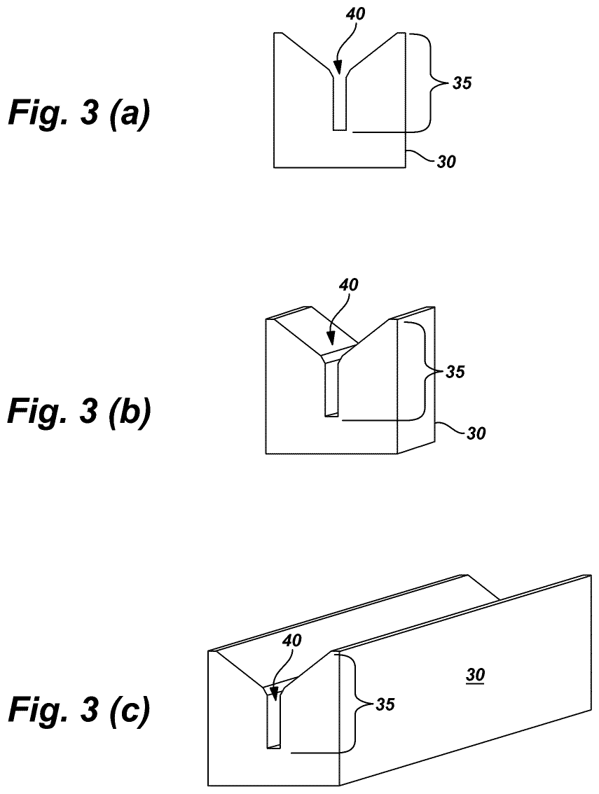

The advanced grease capturing insert 10 can also be provided with a plurality of inverted V-shaped diverters 70. These V-shaped diverters 70 guide the grease that drops from the food that's being cooked on the grill 15 down into the “Y” shaped channels of the drainage tray 31; shown in detail in FIGS. 3(a)-(c). The V-shaped diverters 70 are attached to the drainage tray 31 by two cross beams 16. The drainage tray 31, the V-shaped diverters 70 and the cross beams 16 can each be made of metal, a metallic alloy or a ceramic material. The insulation wall 80 is preferably made of a heavy insulation material, such as cement, for example. So that the lower end 33 of the drainage tray 31 is able to sustain the elevated end 32 of the drainage tray 31 at the greater height.

The grease-capturing insert 10 is designed to fit inside the barbecue grill 15 and the grease drainage tray 31 is designed at an angle to utilize gravity to move grease away from any heat source 50. Unlike most prior art products that focus on horizontal grease trays this angled design significantly improves grease management within the barbecue grill 15. Additionally, the interior design of the drainage tray 31 minimizes oxygen exposure thereby reducing the risk of fire and flare-ups, a unique feature not addressed in other products.

The insert 10 also has an insulation layer 20 to lower the temperature within the drainage tray 31 and ensure that grease is removed safely; another distinctive element that is not commonly found in existing products. By directing grease away from the heat source 50 into the grease collection tray 60, the design enhances safety; surpassing many existing solutions that rely on simple trays or cups that do not efficiently direct grease away from the heat source 50. Many prior art products simply don't work, failing to adequately manage grease and prevent flare-ups. The present innovative design effectively solves the problem of grease fires and flare ups on the barbecue grill 15, provides tastier food and more importantly does both more safely.

In an alternative embodiment, the grease-capturing insert 10 may be integrated into a barbecue grill 15 during the manufacturing process. In such configurations, the grease drainage tray 31 and associated components may be permanently installed or built into the grill structure, with the channel members 30 and V-shaped diverters 70 forming an integral part of the barbecue grill's 15 cooking surface assembly. The grease collection tray 60 may be designed as a removable drawer or permanent collection system that is accessible for cleaning and maintenance. This integrated approach may provide enhanced structural stability and optimized spacing for the grease management system while maintaining all the safety and performance benefits of the removable insert embodiment.

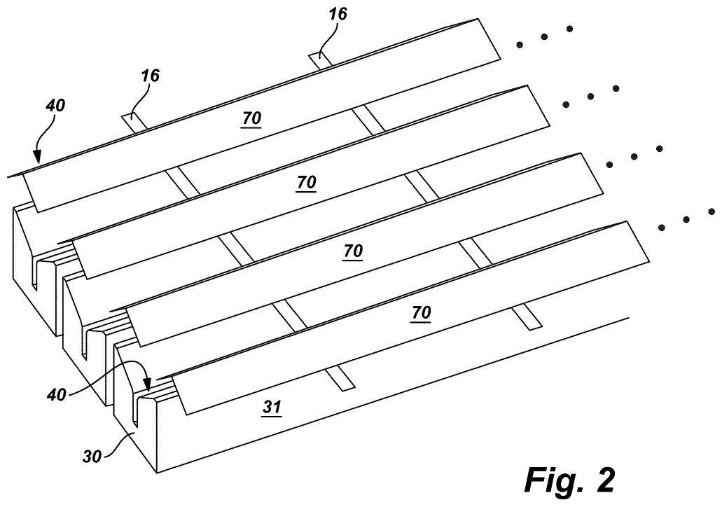

FIG. 2 is a top perspective cut-off view of the preferred embodiment of the advanced grease capturing insert 10 for the barbecue grill 15. At the very top of the grease drainage tray 31 are the V-shaped diverters 70. The V-shaped diverters 70 sit on top of the cross beams 16. The cross beams 16 sit on top of the plurality of channel members 30. In the center of each channel member 30 is a narrow center channel 40. The grease drainage tray 31, the V-shaped diverters 70 and the cross beams 16 are preferably constructed from stainless steel; chosen for its durability, resistance to high temperatures and ease of cleaning.

FIG. 3(a) is a frontal view of a single channel member 30. Each channel member 30 contains a Y-shaped cross-section 35. The bottom portion of each “Y” defines the narrow center channel 40 of each channel member 30 wherein the grease collects and is deprived of oxygen. This deprivation of oxygen is one of the key features of the invention; preventing fires and flare ups within the grease drainage tray 31. The front of each channel member 30 faces the grease collection tray 60 (shown in FIG. 1), thus allowing grease to drip directly there into.

FIG. 3(b) is a perspective view of the single channel member 30. The figure is intended to show the channel member 30 with the Y-shaped cross-section 35 has length, and the narrow center channel 40 extends the entire length.

FIG. 3(c) is another perspective view of the same single channel member 30. Again, the figure is intended to show that the channel member 30 with Y-shaped cross-section 35 has length, and the narrow center channel 40 extends the entire length.

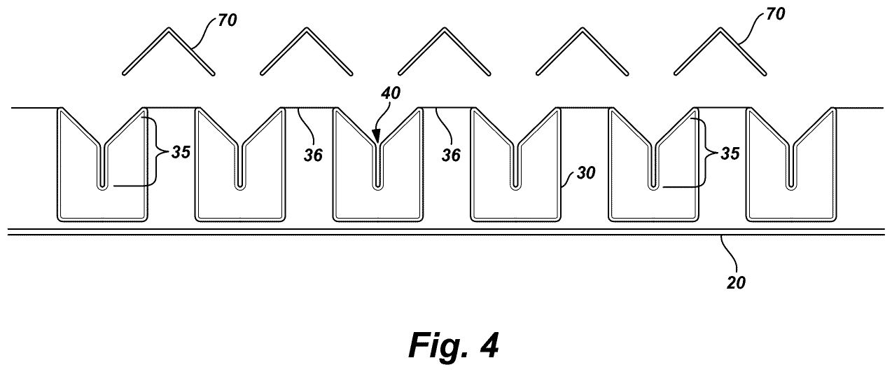

FIG. 4 shows a plurality of channel members 30 being linked together to make up a drainage tray 31 (shown in FIGS. 1 and 2). Links 36 are preferably made of the same material as the channel members 30. In the preferred embodiment, a V-shaped diverter 70 is placed above each link 36. This orientation of the V-shaped diverters 70 guides all grease drops that drop from food being cooked above down into the Y-shaped cross-sections 35 of the channel members 30 below. The grease is then funneled down into the narrow center channels 40 where the grease is deprived of oxygen, thereby making flare ups impossible.

An insulation layer 20 provides an added layer of protection by isolating the grease from the heat source 50. The channel members 30, the links 36, and the V-shaped diverters 70 are preferably made of stainless steel. The insulation layer 20 preferably has a stainless steel exterior and a layer of non-flammable material as the interior. In other alternative embodiments, the channel members 30, the links 36, and the V-shaped diverters 70, and the exterior of the insulation layer 20, can be made of other materials including carbon steel, ceramics, cast iron and high-temperature composites.

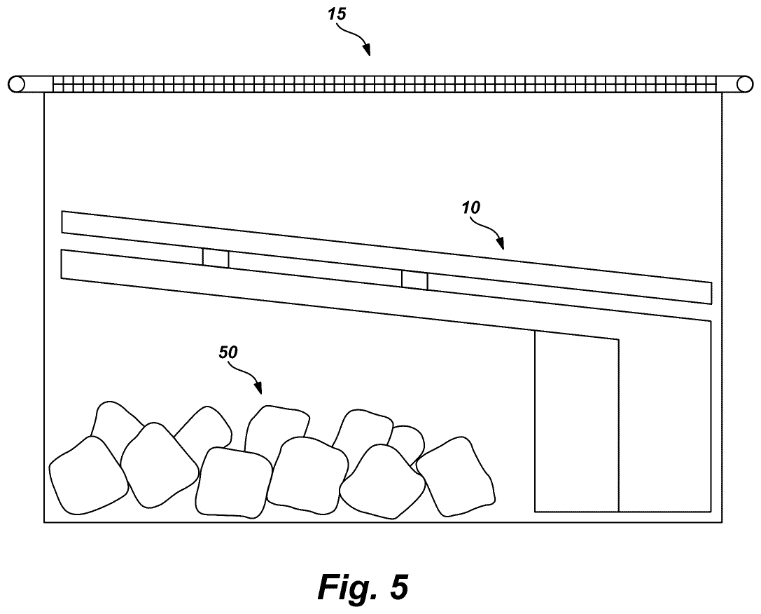

FIG. 5 shows the preferred embodiment of the grease capturing insert 10 in operational position inside the barbecue grill 15. In traditional barbecue grills 15, like those found in public parks, the lid is also the grill that food is cooked on. Users can lift the lid and put in a heat source 50, such as charcoal briquets, and then put in the present grease capturing insert 10. The grease capturing insert 10 is able to sit on the bottom of the barbecue grill 15. What makes this grease-capturing insert 10 unique is its combination of an angled drainage tray 31 with Y-shaped cross-section 35 channel members 30 with a narrow center channel 40 that minimizes oxygen exposure, integrated with an insulated system for safe grease removal. Unlike existing solutions that rely on horizontal trays or simple grease cups, this design's downward sloping angle leverages gravity for efficient grease flow away from the heat source 50. The Y-shaped cross-section 35 directs grease into a specifically narrow center channel 40 that significantly reduces oxygen exposure, consequently minimizing flare-ups and fire risks. The added insulation layer 20 ensures that the grease does not overheat, further enhancing safety. This integrated approach to grease management within the barbecue grill 15—combining slope, shape, narrow center channel 40, and insulation layer 20—is a distinctive and innovative solution that simultaneously addresses multiple grilling safety issues.

While a particular form of the invention has been illustrated and described, it will be apparent that various modifications can be made without departing from the spirit and scope of the invention. For example, the insert 10 could be provided in the round shape. Accordingly, it is not intended that the invention be limited, except as by the appended claims.

Particular terminology used when describing certain features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific embodiments disclosed in the specification, unless the above Detailed Description section explicitly defines such terms. Accordingly, the actual scope of the invention encompasses not only the disclosed embodiments, but also all equivalent ways of practicing or implementing the invention.

The above detailed description of the embodiments of the invention is not intended to be exhaustive or to limit the invention to the precise form disclosed above or to the particular field of usage mentioned in this disclosure. While specific embodiments of, and examples for, the invention are described above for illustrative purposes, various equivalent modifications are possible within the scope of the invention, as those skilled in the relevant art will recognize. Also, the teachings of the invention provided herein can be applied to other systems, not necessarily the system described above. The elements and acts of the various embodiments described above can be combined to provide further embodiments.

All of the above patents and applications and other references, including any that may be listed in accompanying filing papers, are incorporated herein by reference. Aspects of the invention can be modified, if necessary, to employ the systems, functions, and concepts of the various references described above to provide yet further embodiments of the invention.

Changes can be made to the invention in light of the above “Detailed Description.” While the above description details certain embodiments of the invention and describes the best mode contemplated, no matter how detailed the above appears in text, the invention can be practiced in many ways. Therefore, implementation details may vary considerably while still being encompassed by the invention disclosed herein. As noted above, particular terminology used when describing certain features or aspects of the invention should not be taken to imply that the terminology is being redefined herein to be restricted to any specific characteristics, features, or aspects of the invention with which that terminology is associated.

While certain aspects of the invention are presented below in certain claim forms, the inventor contemplates the various aspects of the invention in any number of claim forms. Accordingly, the inventor reserves the right to add additional claims after filing the application to pursue such additional claim forms for other aspects of the invention.

What is claimed is:

1. A grease-capturing insert adapted for use with a barbecue grill having a heat source, the grease-capturing insert comprising:
a multi-channel grease drainage tray having an elevated end having a height greater than that of a lower end, the multi-channel grease drainage tray comprising:
a plurality of channel members, each comprising a narrow center channel running longitudinally along a length of a Y-shaped cross-section of the channel member, wherein grease that drops from food being cooked on the barbecue grill is directed into the Y-shaped cross-section of each channel member and funneled down into the narrow center channel;
an insulation layer disposed along a bottom of the grease drainage tray providing heat insulation between the drainage tray and the heat source;
a grease collection tray fluidly connected to the lower end of the grease drainage tray, wherein grease collected in the grease drainage tray drains by gravity from the lower end into the grease collection tray;
an insulation wall attached to the lower end of the drainage tray and interior to the grease collection tray, the insulation wall providing heat insulation for the grease collection tray from the heat source.

2. The grease-capturing insert of claim 1, further comprising:
a plurality of V-shaped diverters inverted and positioned above and between each channel member.

3. The grease-capturing insert of claim 2, further comprising:
two cross beams, wherein the two cross beams lay in between the grease drainage tray and the plurality of V-shaped diverters and further wherein the two cross beams are used to attach the grease drainage tray to the plurality of V-shaped diverters.

4. The grease-capturing insert of claim 1, wherein all of the channel members are positioned substantially parallel to each other in the grease drainage tray.

5. The grease-capturing insert of claim 1, wherein the channel members and diverters are constructed from stainless steel.

6. The grease-capturing insert of claim 1, wherein the insert fits inside the barbecue grill.

7. The grease-capturing insert of claim 1, wherein the channel members and diverters are constructed from carbon steel.

8. The grease-capturing insert of claim 1, wherein the channel members and diverters are constructed from ceramics.

9. The grease-capturing insert of claim 1, wherein the channel members and diverters are constructed from cast iron.

10. The grease-capturing insert of claim 1, wherein the channel members and diverters are constructed from high-temperature composites.

11. A barbecue grill having a heat source and comprising an integrated grease-capturing system, the integrated grease-capturing system comprising:
a multi-channel grease drainage tray having an elevated end having a height greater than that of a lower end, the multi-channel grease drainage tray comprising:
a plurality of channel members, each comprising a narrow center channel running longitudinally along a length of a Y-shaped cross-section of the channel member, wherein grease that drops from food being cooked on the barbecue grill is directed into the Y-shaped cross-section of each channel member and funneled down into the narrow center channel;
an insulation layer disposed along a bottom of the grease drainage tray providing heat insulation between the drainage tray and the heat source;
a grease collection tray fluidly connected to the lower end of the grease drainage tray, wherein grease collected in the grease drainage tray drains by gravity from the lower end into the grease collection tray;
an insulation wall attached to the lower end of the drainage tray and interior to the grease collection tray, the insulation wall providing heat insulation for the grease collection tray from the heat source.

12. The barbecue grill of claim 11, further comprising:
a plurality of V-shaped diverters inverted and positioned above and between each channel member.

13. The barbecue grill of claim 11, further comprising:
two cross beams, wherein the two cross beams lay in between the grease drainage tray and the plurality of V-shaped diverters and further wherein the two cross beams are used to attach the grease drainage tray to the plurality of V-shaped diverters.

14. The barbecue grill of claim 11, wherein all of the channel members are positioned substantially parallel to each other in the grease drainage tray.

15. The barbecue grill of claim 11, wherein the channel members and diverters are constructed from stainless steel.

16. The barbecue grill of claim 11, wherein the channel members and diverters are constructed from carbon steel.

17. The barbecue grill of claim 11, wherein the channel members and diverters are constructed from ceramics.

18. The barbecue grill of claim 11, wherein the channel members and diverters are constructed from cast iron.

19. The barbecue grill of claim 11, wherein the channel members and diverters are constructed from high-temperature composites.
